(19) United States
(12) Patent Application Publication
(10) Pub. No.: US 2005/0016065 A1
(43) Pub. Date: Jan. 27, 2005

(54) Sash window counterbalance brake arrangement

(75) Inventor: Simon Christopher Braid, Maxey (GB)

Correspondence Address: RICHARD M. GOLDBERG, 25 EAST SALEM SREEET, SUITE 419, HACKENSACK, NJ, 07601, US

(73) Assignees: Harold Keith Braid, Edenham (GB); Simon Christopher Braid, Maxey (GB)

(21) Appl. No.: 10/899,492

(22) Filed: Jul. 26, 2004

(30) Foreign Application Priority Data
Jul. 26, 2003 (GB) 0317542.9

(51) Int. Cl. E05F 1/00

(52) U.S. Cl. 49/181; 49/445

(57) ABSTRACT

A locking balance shoe (42) for a sash window counterbalance arrangement includes at least one moveable locking abutment element (58,60). A cam (44) of the balance shoe (42) is moveable to operatively move and urge the at least one moveable locking abutment element (58,60) from the first unlocked position to a second engaged locking position. The at least one moveable locking abutment element (58,60) is diagonally movable and is moved diagonally by the cam (44) and in the second engaged position the at least one moveable locking abutment element (58,60) engages and abuts against and within a corner region of the window jamb channel (32) between a pair (11,13) of walls of the window jamb channel (32) to frictionally lock the balance shoe (42) in place.

The present invention relates to sash windows and to a slidable mounting arrangement for a sash window within a sash window frame. In particular it relates to a sash window counterbalance balance shoe arrangement in which a slidable balance shoe of a sash window counterbalance assembly comprises and includes a braking arrangement to selectively lock and prevent slidable movement of the sash shoe and so of the sash window. This selective locking in particular allows the sash window to be removed and/or tilted from a vertical position for cleaning, replacement or repair without the sash window counterbalance arrangement moving as the weight of the sash window is removed.

Vertically sliding sash windows include a counterbalance arrangement to counterbalance and offset the weight of the sash window to allow for easier opening and sliding of the sash window within the window frame. Such counterbalance arrangements, in modern sash windows, typically comprise a spring arrangement within window jamb channels. One end of the spring arrangement is attached to a slidable sash shoe slidably located within a window jamb channel with the other end of the spring arrangement fixed to and within the window jamb. The sash window is attached to the sash shoe, typically at a lower end, by means of a laterally projecting lower mounting pin which engages the sash shoe. An upper end of the sash window is slidably located in the window frame by means of laterally extending upper mounting pins which are engaged in the window jamb channel such that the sash window is slidably vertically located within the window frame.

For cleaning of the window, repair, maintenance or installation/removal, it is common for the sash window to be arranged such that it can be tilted from its installed vertical plane typically about the lower pin mountings with the upper mounting pin being retracted or otherwise disengaged from the window jamb channel to allow the window to be so tilted. As the sash window is tilted the force acting vertically upon the counterbalance arrangement due to the weight of the sash window is reduced. Accordingly to prevent the sash window undesirably, and potentially dangerously, vertically moving within the frame as it is tilted it is known to provide a locking arrangement to selectively lock the sash window counterbalance arrangement in a vertical position in the window jamb when the sash window is tilted. Most commonly such a locking arrangement comprises selectively locking the sash shoe within the window jamb channel by suitable frictional engagement of moveable portions of the sash shoe with opposite walls of the window jamb channel. Such arrangements are well known and various different detailed arrangements are described for example in U.S. Pat. No. 4,590,708, U.S. Pat. No. 4,718,194, U.S. Pat. No. 4,610,108, U.S. Pat. No. 5,237,775, U.S. Pat. No. 5,371,971, U.S. Pat. No. 5,414,960, U.S. Pat. No. 6,119,398.

As described in these prior arrangements the sash shoe typically comprises a rotatable locking cam member within which the lower mounting pin of the sash window is located and engaged. The locking cam is arranged to be rotated within the sash shoe by the rotation of the lower mounting pin as the sash window is tilted. Rotation of the locking cam is arranged to urge various locking members and/or locking arms/portions of the sash shoe outwards and into abutting frictional engagement with the side walls of the window jamb channel to thereby lock the sash shoe in position vertically within the channel. In most of these arrangements the locking members and/or locking arms/portions of the sash shoe are simply urged outwards against the side walls of the window jamb channel. In U.S. Pat. No. 6,119,398 this basic arrangement is improved with a three directional locking arrangement in which in addition there is a further separate locking member which is urged rearwards against a rear wall to provide a more secure locking of the sash shoe.

Whilst these prior proposed arrangements provide a degree of locking of the sash shoe, and sash window, it would be desirable to improve the locking of the sash shoe within the window channel jamb. Indeed the number of prior proposals for such locking arrangements in itself indicates the need for an improved locking arrangement and that current arrangements are not sufficient. In particular windows are increasingly becoming heavier, with the windows now for example including double or triple glassing, and other improved thermal and security features which add to the weight. As a result the counterbalance arrangements have to provide larger forces to counterbalance the larger weights. Consequently the sash shoe locking arrangements must be improved to resist such higher counterbalance forces.

In addition in these arrangements the lower mounting pin of the sash window is located and engaged within the sash shoe, and in particular within the locking cam. The mounting pin and its engagement with the locking cam is arranged such that it rotates the locking cam when the sash window is tilted. To facilitate installation and removal of the sash window the mounting pin is arranged to be easily removable from the locking cam. Accordingly the locking cam typically includes a slot or key way within which a head portion of the mounting pin is slotted and engaged. The sash shoe also includes a slot passageway with which the slot of the locking cam can be aligned to allow the head of the mounting member can be slid out of the locking cam and sash shoe so that the sash window can be removed. Such an arrangement is specifically further described in U.S. Pat. Nos. 5,927,013, U.S. Pat. No. 6,058,653, and U.S. Pat. No. 5,704,165. Whilst such arrangements allow for easy installation and removal of the sash window, there is a risk with these arrangement of inadvertent removal of the mounting pin form the sash shoe, and the mounting arrangement can be improved.

It is therefore desirable to provide an improved sash window counterbalance balance brake/locking arrangement which provides improved braking/locking of the counterbalance arrangement and/or which offers improvements generally.

According to the present invention there is provided a locking balance shoe as described in the accompanying claims. There is also provided a method of locking a sash window balance shoe as also described in the accompanying claims.

In an aspect of an embodiment of the invention there is provided a locking balance shoe for a sash window counterbalance arrangement. The balance shoe is slidably mounted within a window jamb channel defined by a plurality of walls. The balance shoe comprises a main body, at least one moveable locking abutment element, and a cam mounted within the main body movable. The at least one moveable locking abutment element is moveable from a first unlocked position to a second engaged locking position in which, in use, the at least one locking abutment element abuts and frictionally engages a wall of the window jamb channel. The cam mounted within the main body which is moveable to operatively move and urge the locking abutment element from the first unlocked position to a second engaged locking position. The at least one moveable locking abutment element is diagonally movable and is moved diagonally by the cam with respect the main body and channel with in the second engaged position the at least one moveable locking abutment element is arranged to engage and abut against and within a corner region of the window jamb channel between a pair of said a plurality of walls of the window jamb channel.

In such an arrangement and diagonal movement of the at least one moveable locking element into a corner of the channel provides improved and more secure locking of the sash shoe within the channel with the sash shoe locked by a single diagonal locking movement simultaneously in two directions with the at least one moveable locking element simultaneously abutting two walls of the channel.

Preferably the locking balance shoe comprises at least four moveable locking elements which are operatively moveable by the cam in four generally opposed directions.

The at least one moveable locking abutment element preferably comprises a pair of opposed diagonally moveable locking elements. Furthermore the locking balance shoe preferably further comprises a further pair of laterally moveable locking elements which are arranged to abut against opposed lateral walls of the window jamb channel. The pair of laterally moveable locking elements may comprise legs which extend and are cantilevered from the main body, the legs having a distal free end which can be flexed outwards. The legs may include pockets comprises voids defined within the legs.

The cam may comprise a generally cylindrical member rotatably mounted within the balance shoe. The cam includes a first curved cam surface, and the at least one diagonally movable locking abutment elements include cooperating curved surfaces which abut against the first curved cam surface. The first curved cam surface comprises a circumferentially extending axial end portion of the cylindrical cam.

Preferably the locking balance shoe comprises a plurality of moveable locking abutment elements all of which abut against the cam such that the cam operatively simultaneously moves and urges all of the moveable locking elements.

In another aspect of an embodiment the cam is adapted to be fixedly engaged by a distal end of a pivot pin of the sash window such that the cam is rotate by rotation of the pivot pin. A slot recess is defined within the cam to cooperatively engage a T shaped head of pivot pin. The main body may also include an removal slot defined therein with which the slot recess of the cam can be aligned to allow sliding removal of the pivot pin along the slot and from engagement in the cam. Preferably the removal slot defined in the main body diverges and widens from and end adjacent to the cam. A removal slot closure element fits into and substantially fills the removal slot in the main body. Lateral flanges may project from the removal slot closure element and are slidingly engaged within corresponding recesses defined in removal slot to retain the closure element within the removal slot.

Also in a further aspect of an embodiment the at least one diagonally moveable locking abutment element is interconnected to the main body by a relatively flexible interconnection. The interconnection between the at least one diagonally moveable locking abutment element and main body may comprise a reduced cross section connection. Preferably the interconnection between the at least one diagonally moveable locking abutment element and main body comprises an S shaped interconnection which extends from the main body in a S shape to provide an extended interconnection path there between.

The locking balance shoe may be made from moulded plastic.

In an embodiment of a further aspect of the invention there is also provided a method of locking a sash window balance shoe within a sash window jamb channel. The method comprises providing the sash window balance shoe with at least one movable locking abutment element. Moving the at least one movable locking abutment element from a first unlocked position to a second engaged locking position in which, in use, the at least one locking abutment element abuts and frictionally engages a wall of the window jamb channel. The moving of the at least one moveable locking abutment element comprising diagonally moving the at least one moveable locking abutment element diagonally outwardly relative to the sash window balance shoe to in the second engaged locking position engage and urge the at least one moveable locking abutment element against and within a corner region of the window jamb channel between a pair of said a plurality of walls of the window jamb channel.

The method similarly provides a more secure locking of a sash window balance shoe within a sash window jamb channel.

Preferably the at least one movable locking abutment element comprises a pair of oppositely movable opposed locking abutment elements. The method may further comprise providing a pair of laterally moveable locking elements and moving the pair of laterally moveable locking elements oppositely laterally outwards to abut against opposed lateral walls of the window jamb channel substantially simultaneously with moving the at least one moveable locking abutment element diagonally outwardly.

Preferably the method comprises providing at least four moveable locking elements and moving the at least four moveable locking elements in four generally opposed respective directions.

In the method of a described embodiment the moving of the at least one moveable locking abutment element comprises rotating a locking cam rotatably disposed in sash window balance shoe, the locking cam which has a profiled cam surface which abuts against and actuates the at least one moveable locking abutment element.

The present invention will now be described by way of example only with reference to the following figures in which:

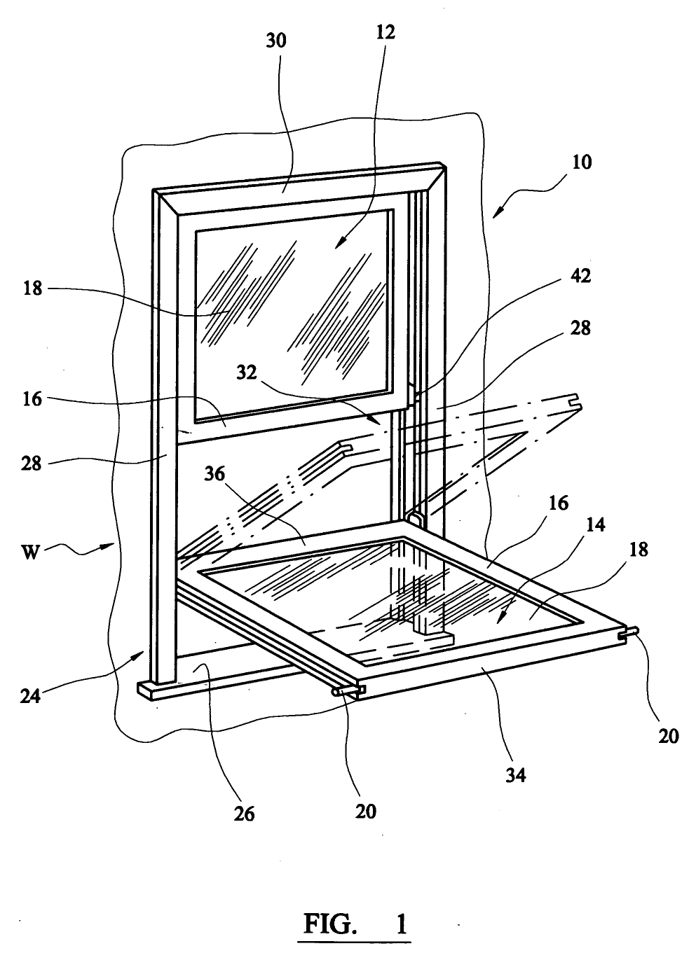

FIG. 1 is a perspective illustrative view of a sash window assembly with a lower sash window in a titled position;

FIG. 2 is an exploded perspective more detailed illustration of a sash shoe assembly and mounting pin according to an embodiment of the present invention as viewed in perspective in a direction from the window jamb channel as indicated by arrow W in FIG. 1;

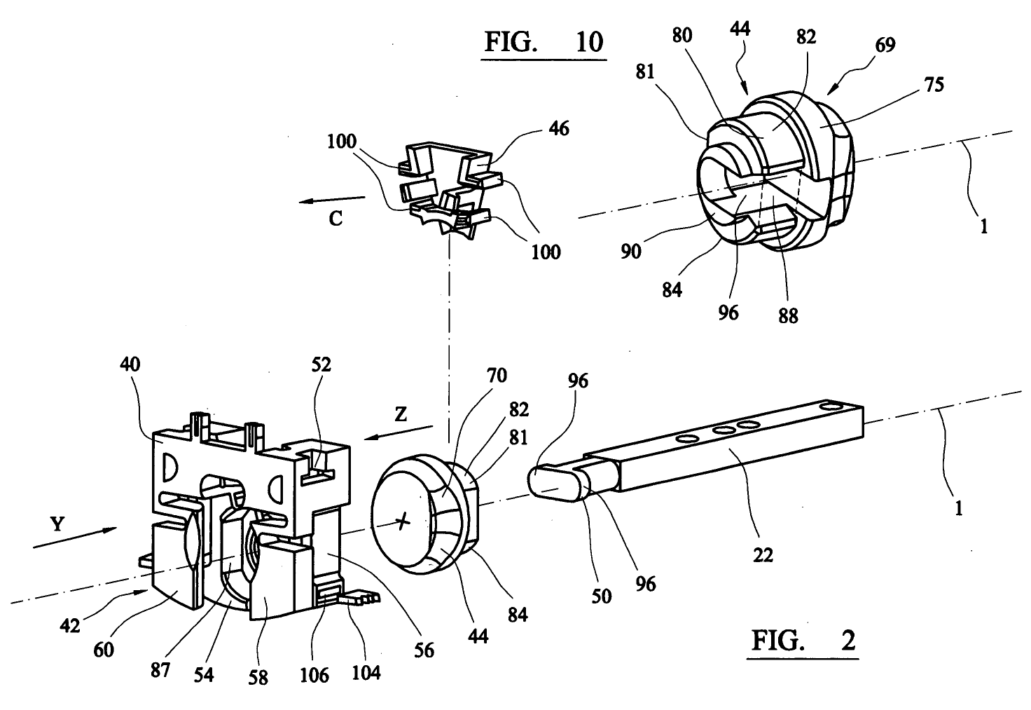

FIG. 3 is a rear view of the sash shoe assembly shown in FIG. 2 as viewed in the direction of arrow Y;

FIG. 4 is a front view of the sash shoe assembly shown in FIG. 2 as viewed in the direction of arrow Z;

FIG. 5 is a rear view of the locking cam alone of sash shoe assembly shown in FIG. 2;

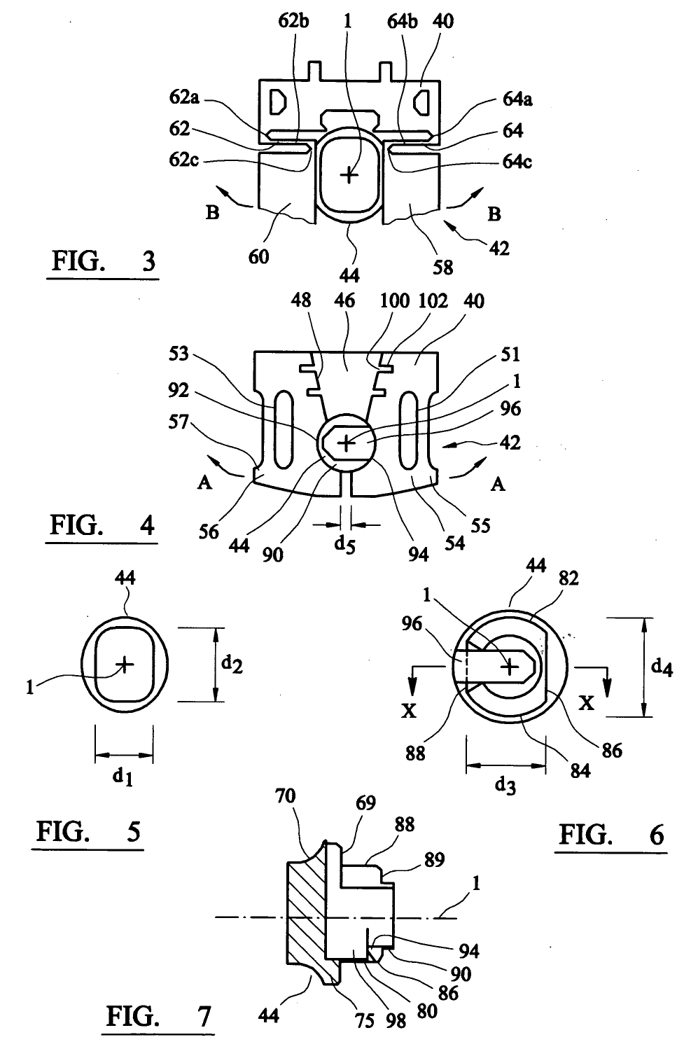

FIG. 6 is a front view of the locking cam alone of sash shoe assembly shown in FIG. 2;

FIG. 7 is a cross sectional view, along line X-X through the locking cam of sash shoe assembly shown in FIG. 2;

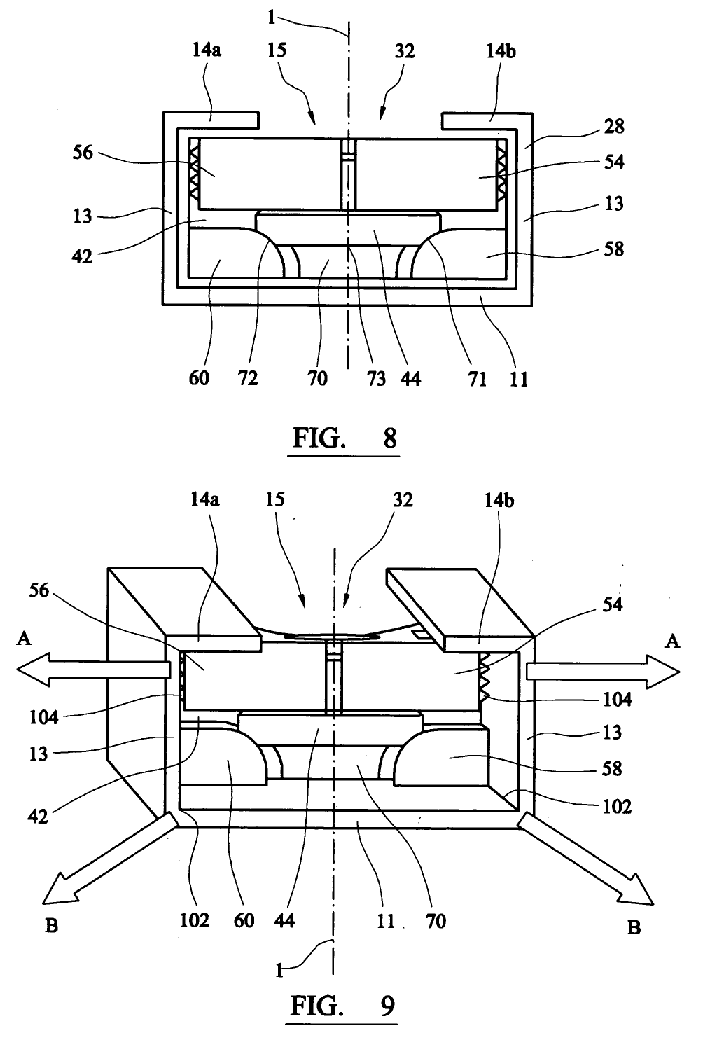

FIG. 8 is a horizontal cross sectional view of the lower end of the sash shoe shown in FIG. 2 mounted within a window channel jamb of a sash window frame with the sash shoe in an unlocked configuration;

FIG. 9 is a perspective horizontal cross sectional view similar to that of FIG. 8, but showing the sash shoe in a locked configuration; and

FIG. 10 is a perspective illustrative front side view of the cam shown in FIG. 2 showing the opposite perspective front side view of the cam to that shown in FIG. 2.

Referring to FIG. 1, a sash window 10 comprises upper 12 and lower 14 sashes which are slidably mounted within a window frame 24 such that each sash 12,14, can be slid vertically to open the window 10. The sashes 12,14, are disposed generally vertically in an overlapping arrangement with one disposed closely adjacent to the other and in operation sliding behind each other. Each sash window 12,14 comprises a peripheral frame 16 surrounding and enclosing a glass window pane 18.

The window frame 24 comprises a top header 30 and a bottom sill 26 horizontal frame members and two vertical laterally spaced window jamb members 28. The window jamb members 28, each define and include a pair of double vertically extending window jamb channel sections 32. Each channel section 32 of the double channel section is generally similar and each is associated with a respective sash window 12,14. As will be explained further later on the sash window sashes 12,14 are slidably located and engaged with each respective channel section 32. The window jamb channel sections 32, of the double channel section in each window jamb 28, are disposed side by side adjacent to and along the length of the window jamb 28, adjacent to the lateral side of a respective sash window 12,14. Each channel section 32 is defined by a rear wall 11, pair of side walls 13 projecting forward from the rear wall 11 and a pair of front walls 14a,14b, which are parallel and spaced from the rear wall 11 and partially close off the channel section 32. An open part 15 of the channel section 32 faces the respective lateral side of the sash window 12,14. The window frame 24, and window jamb channels 32 are typically fabricated from extruded uPVC sections which are joined together to form the window frame 24.

Lower mounting pivot pins 22, located towards the lower part of the window sashes 12,14, extend and project laterally from the sides of the window sashes 12,14 at the bottom end of the window sashes 12,14. The pivot pins 22 project into the window jamb channel 32 and are engaged within a respective sash shoe 42 slidably located within the window jamb channel 32. Tilt latches 20, or pins, located towards the upper part of the sash window sashes 12,14, similarly project laterally from the sides of the sash window sashes 12,14. The distal ends of the tilt latches 20 are located and project within the open part 15 of the respective window jamb channels 32. The sash windows sashes 12,14, are thereby slidably located within and with respect to the window frame 24 by the locating of the pivot pins 22 and tilt latches 20 within the window jamb channels 32. The tilt latches 20 are also laterally retractable with respect to the sash window 2,4, such that the distal ends of the tilt latches 20 can be withdrawn from the window jamb channel sections 9. This allows the upper part of the sash window sashes 12,14 to be disengaged allowing the sash window sashes 12,14 to be tilted and pivoted about the pivot pins 22 as shown in FIG. 1.

Spring counterbalance mechanisms, to counterbalance the weight of the sash windows 12,14 and make vertical sliding of the sash windows 12,14, easier, are mounted and located within the channel sections 32 of the window jambs 28. Such counterbalance arrangements are described for example in U.S. Pat. No. 6,393,661, U.S. Pat. No. 6,412,144, GB 2369644 (which are incorporated herein by reference) amongst many others. It will also be appreciated that other spring and other counterbalance arrangements can be used. For each sash window sash 12,14 a pair of spring counterbalance mechanisms are provided, one on each lateral side of the sash window sashes 12,14, with the mechanisms for each sash window sash 12,14 located and mounted within the respective channel section 32 in the window jamb 28. The spring counterbalance mechanisms comprise a spring arrangement comprising one or more springs (not shown), which are located and supported by and within a spring support mounting (not shown) affixed to the window jamb within the channel section 32. An end of the spring is connected to a respective sash shoe 42 which is slidably located within the window jamb channel section 32. In operation, as the sash window sashes 12,14 are slid vertically within the window frame 5 the sash shoe 28 which is connected thereto slides vertically within the window jamb channel 32 and extends the spring. The vertical spring tension force thereby counterbalances and offsets the weight of the sash window sashes 12,14.

As described above the arrangement is generally conventional.

When the sash window sashes 12,14 are tilted, as shown in FIG. 1 the force acting vertically upon the counterbalance arrangement due to the weight of the sash window sashes 12,14 is reduced. Accordingly to prevent the sash window sashes 12,14 undesirably, and potentially dangerously, moving vertically within the window frame 24 the sash shoe 42 incorporates a locking arrangement to selectively lock the sash shoe 42 in position within the window jamb channel 32 to lock the sash window counterbalance arrangement in a fixed vertical position within the window frame 24 automatically when the sash window sashes 12,14 are tilted.

Referring to FIGS. 2 to 8 the details of the sash shoe 42, and locking arrangement thereof are shown in more detail. The sash shoe 42 comprises a main shoe body 40 dimensioned to generally fit and slide within the channel section 32, a rotatable cam 44 located and engaged within the main shoe body 40 and into which a distal end 50 of the lower pivot mounting pin 22 is engaged, and a wedge shaped closure element 46 located and engaged within a corresponding vertical extending wedged shaped recess 48 in the main shoe body 40. The wedged shaped recess 48 provides a throat opening for the pivot pin 22 to be vertically slotted into the cam 44 as will be explained later on. The sash shoe 42, and component parts thereof are preferably fabricated from a plastic mouldings, whilst the pivot pin 22 typically comprises a metal component.

The sash shoe main body 40 includes a T shaped slot recess 52 on one side into which a correspondingly T shaped end of the spring assembly (not shown) of the counterbalance assembly is located and engaged to attach the sash shoe 42 to the spring assembly. Other arrangements known in the art could of course instead be used to attach the spring to the sash shoe 42.

A front portion of the main shoe body 40, which when the sash shoe 42 is installed within the channel 32 is adjacent the front walls 14a,14b and open part 15 of the channel 32 and faces the respective lateral side of the sash window sashes 12,14, includes a pair of parallel spaced apart legs 54,56. The front of the sash shoe 42 is shown more clearly in FIG. 4. The legs 54,56 extend longitudinally with respect to the channel 32 into which the sash shoe 42 is installed and are cantilevered from an upper part of the main shoe body 40 each having a distal free end 55,57. The legs 54,56 are spaced apart such that there is a gap d₅ defined between the distal ends 55,57 of the legs 55,56. The legs 54,56 are sufficiently flexible such that they can be deflected by rotation of the cam 44 laterally outwards and laterally apart. This opens up the gap d₅ between the distal ends 55,57 of the legs 55,56, and urges the distal ends 55,57 of the legs 55,56 apart to abut against the lateral side walls 13 of the channel 32 to frictionally lock or brake the sash shoe 42 within the channel 32. The resilience of the plastic material from which the sash shoe 42 is moulded and the cantilevering of the legs 54,56 from the upper part of the main shoe body 40 provides the required flexibility. In addition longitudinal elongate pockets or slots 51,53 are defined in the legs 54,56. These pockets 51,53 have the effect of reducing the cross sectional area of the legs 54,56, increasing the flexibility of the legs 54,56 and the cantilevered legs 54,56 to be bent laterally outwards more easily.

To improve the locking of the sash shoe 42 within the channel 42 and the engagement of the legs 54,56 with the lateral side walls 13 the distal ends 55,57 of the legs 54,56 may include metal teeth inserts 104. The metal inserts 104 are located and mounted within corresponding recesses 106 in the legs 54,56, and include a serrated distal end which projects laterally outwards from the legs 54,56. When the legs 54,56 are urged outwards towards the side walls 13 to lock the sash shoe the metal teeth 104 are urged into the side walls 13 and dig into and engage the plastic side walls 13 of the window channel 32 to improve the locking of the shahs shoe 42 within the channel 32.

A rear portion of the main shoe body 40, which when the sash shoe 42 is installed within the channel 32 is adjacent the rear wall 11 of the channel 32, includes a pair of parallel spaced apart moveable locking blocks 58,60. The rear portion of the main shoe body 40 and locking blocks 58,60 are shown more clearly in FIG. 3 The locking blocks 58,60 are disposed behind and adjacent to the front legs 54,56 and are separate and spaced from the legs 54,56 as can be seen in FIG. 8. The locking blocks 58,60, are interconnected to the upper part of the remainder of the main shoe body 40 by a reduced cross section S shaped interconnection or neck 62,64 which is significantly thinner than the locking blocks 58,60. This S shaped interconnection 62,64 comprises a relatively short first portion 62a,64a extending longitudinally from the upper part of the remainder of the main shoe body 40 to an elongate lateral second portion 62b,64b extending normally to the first portion 62a,64a in a lateral direction across the shoe body 40, and which connects to a further relatively short third portion 62c,64c extending longitudinally from the end of the laterally extending second portion 62b,64c to the locking block 58,60. The first and third longitudinal extending portions 62a,62c,64a,64c extend parallel to each other and are laterally spaced apart and connected by the second lateral extending portion 62b,64b. This S shaped interconnection 62,64 by virtue of the reduced cross section of the interconnection and extended length of interconnection over which the interconnection can flex as well as the S shaped arrangement of the interconnection provides a suitably flexible interconnection of the locking blocks 58,60 to the upper part of the remainder of the main shoe body 40. The locking blocks 58,60 are accordingly sufficiently moveable to be able to be deflected and moved by the cam 44 diagonally outwardly with respect to the shoe main body 40 in both a lateral and also a rearward direction (as shown by arrow B in FIGS. 3 and 9) and into the corner regions of the channel 32 between the rear 11 and side walls 13 of the channel 32.

The rotatable cam 44 is generally cylindrical and is rotatably located within the main shoe body 40 such that it can be rotated about an axis 1 extending centrally through the main shoe body 40 perpendicular to the sash shoe 42. The cam 44 cooperatively and snugly fits into the main shoe body 40 between, and is enclosed by, the locking blocks 58,60 and legs 54,56 as shown in FIGS. 3,4 and 8,9. The locking blocks 58,60 and legs 54,56 define a recess or enclosure for the cam 44. A central circular cross sectional cylindrical portion of the cam 44 has a axial peripheral annular flat face 69 which abuts against a flat inner end face of the back of the legs 54,56 to axially locate and retain the cam 44. The cam 44 also includes a first and second profiled cam surfaces 70,80 which respectively operatively engage abutting surfaces of the legs 54,56 and locking blocks 58,60 of the sash shoe 42.

The rear end of the cam 44 comprises the curved first cam surface 70 extending circumferentially around the cam 44. This first cam surface 70 abuts against a cooperatively profiled inner curved surfaces 71,72 of the locking blocks 58,60. The first cam surface 70, and inner curved surfaces 71,72 of the locking blocks 58,60, are profiled and shaped such that upon rotation of the cam 44 about the axis 1 the respective locking blocks 58,60 are forced diagonally outwards with respect to the shoe main body 40 in both a lateral and rearward direction (as shown by arrow B in FIGS. 3 and 9) by the cam 44. In particular as shown in FIG. 5 the cam surface 70 has an elliptical end cross sectional profile about the axis 1 of the cam 44 such that a nominal diameter d₁ of the cam surface 70 in a first direction perpendicular to the rotary axis 1 is less than a nominal diameter d₂ of the cam surface 70 in a second first direction normal to the first direction and perpendicular to the rotary axis 1. This difference in nominal diameter d₁,d₂ urges the locking blocks 58,60 in a lateral outward direction upon rotation of the cam 44. The curved axially extending profile of the cam surface 70 also spirals around the circumference (as shown by the slight angled edge 73 in FIG. 8) such that as the cam 44 is rotated the cam surface 70 also forces the locking blocks 58,60 in an axial direction and rearwards. Accordingly in any axial plane (normal to the axis 1) the radial distance of the cam surface 70 from the axis 1 increases circumferentially around an operative circumferential sector, whist at the same time and over the same circumferential sector the radial distance of the cam surface 70 from the axis 1 also increases/decreases in an axial direction.

The inner curved surfaces 71,72 of the locking blocks 58,60, which abut against the curved cam surface 70 better spread the load and allow rotation of the cam 44 than a typical flat surface or other none curved arrangement.

The front end of the cam 44 comprises second cam boss portion 81 coaxially extending from the central circular cross sectional cylindrical portion and defines the second circumferential cam profile and surface 80, and a cylindrical coaxial end boss 90 of a smaller diameter at the end of the cam 44. The cylindrical end boss 90 is received between the legs 56,58 between circular laterally inward facing opposed side walls 92,94 of the legs 56,58 as shown in FIG. 4. An annular end surface 89 of between the end boss 90 and the second cam boss portion 81 abuts and is located behind a rear end recess wall (not shown) of the legs 54,56 such that the cam 44 is securely located and retained axially behind the legs 54,56. The second cam boss portion 81 is similarly received between the legs 54,56 with the circumferential second cam surface 80 abutting against cooperatively shaped laterally inwardly facing opposed respective side walls 87 of the respective legs 54,56. The second circumferential cam profile and surface 80 comprises a pair of opposed arcuate sector portions 82,84 and a pair of opposed parallel spaced apart flats 86,88. The second cam surface 80 and the cooperatively shaped side walls 87 of the legs 54,56 against which they abut are arranged such that upon rotation of the cam 44 the legs 54,56 are urged laterally apart and outwards. In particular the nominal diameter d₄ between the outer profile of the arcuate portions 82,84 is greater than the distance d₃ between the flats 86,88, such that as the cam 44 is rotated the legs are urge laterally apart by the difference between the nominal diameter d₄ and the distance d₃ between the flats 86,88. As shown in FIGS. 6 and 10 flat 88 is defined by a nominal plane between the end edges of the opposed arcuate portions 82,84, but nonetheless functions as a flat 88 of a cam surface 80 when abutting against the cooperatively shaped side walls of the legs 54,56.

A radially extending slot or key way 96 is defined in the front portion of the cam 44 as shown in FIGS. 10 and 6. The key way 96 is dimensioned to receive a generally rectangular cross sectioned T shaped distal end 50 of the pivot mounting pin 22. The T shaped distal end 50 of the pivot mounting pin 22 comprises a pair of oppositely projecting arms 96. As shown in FIG. 7 a locating lip partially closes off an axial end of the key way/slot 96 such that a partially enclosed locating recess 98 is defined for one of the arms of the T shaped head distal end of the mounting pin 22. The arm of the T shaped head distal end of the mounting pin 22 is located within this recess 98 and is axially engaged behind the lip 94 to thereby axially secure and engage the distal head end 50 of the mounting pin 22 within the cam 44. The distal end 50 of the pivot mounting pin 22 is engaged and located within the key way 96 coaxially with the axis 1 of the cam 44, by aligning the distal end 50 within the key way 96 and sliding the distal end in a radial direction into the key way 96. When engaged and located in the key way 96 the cam 44 is secured to the mounting pin 22 and will rotate with the pin 22.

With the cam 44 installed within the shoe main body 40 the key way or slot 96 in the cam 44 can be aligned, by rotating the cam 44, with a cooperative passageway 48 formed in the upper part of the main sash shoe body 40. Referring to FIG. 4 the cam 44 is rotated in a clockwise direction to align the slot 92 with the passageway 48. The passageway 48 extends from the cam 44 through the sash shoe main body 40 in this case in a vertical direction and opens out, when the sash shoe 42 is installed within the window jamb channel 32. Once the slot 92 is aligned with the passageway 48 the pivot pin 22 can be vertically slid into or out of the slot 92 and cam 44 through the passage way 48 to instal or remove the mounting pin 22, and so sash window sashes 12,14 from engagement with the sash shoe 42 located in the window jamb channel 32. To allow the pin 22 to be more easily aligned and slid from the shoe 42 the passage way 48 has a wedge shaped divergent profile diverging and opening out from the cam 44 to a wider opening.

To prevent inadvertent removal of the pin 22 from the slot 96 when the slot 96 is aligned with the passageway 48 a wedge shaped closure element 46 correspondingly shaped to the profile of the passageway 48 is inserted and fitted into the passageway 48. The wedge shaped closure element 46 includes lateral side rib projections 100 which project from the sides of the wedge shaped closure element 46 and are slidingly engaged within corresponding lateral recesses 102 in the sides walls of the passageway 48 in the main shoe body 40. The wedge shaped closure element 46 is laterally slid into the passageway, as indicated by arrow C once the wedge shaped closure element 46 and ribs 100 have been aligned. Since the ribs 100 project laterally from the wedge shaped closure element 46, at an angle to the widening passageway opening 48, they secure the wedge shaped closure element 46 in the passageway 48. The wedge shaped closure element 46 accordingly securely closes off and fills the passage way 48 thereby ensuring, when the closure element 46 is fitted, that the mounting pin cannot be removed, by vertically slid from the slot 96.

In normal use with the window sashes 12,14 generally vertical within the window frame 24 the window sashes 12,14 are free to vertically slide within the frame with the sash shoes 42 to which the window sashes 12,14 are connected sliding freely within the window jamb channels 32. The spring counterbalance arrangements, and spring assemblies connected to the sash shoes 42, counterbalance the weight of the window sashes 12,14 thereby making such vertical sliding relatively easy. In such a condition, with the window sashes 12,14 vertical the cam 44 of the sash shoe 42 is in an first rotational position in which the sash shoe 42 and legs 54,56 and locking blocks 58,60 are not engaged with of the channel 32 with there being a small operative clearance between the legs 54,56 and locking blocks 58,60 such that the sash shoe 42 is free to slide within the channel 32.

When the tilt latches 20 are retracted and disengaged from the window jamb channels 32, the window sashes 12,14 can be tilted from their vertical positions about the lower mounting pivot pins 22, as shown in FIG. 1. The lower mounting pivot pins 22 which are fixed in relation to the window sashes 12,14, and are engaged with the cam 44 within the sash shoe 42, rotate about their locating axis 1 within the sash shoe 42 as the window sashes 12,14 are so tilted. The cam 44 is thereby rotated about the axis 1 from the first rotational unlocked position towards a second locking rotational position in which as the cam 44 is rotated the legs 54,56, and locking blocks 58,60 are urged and moved to their locking positions in which they abut against the channel 32 and channel walls as explained above. The rotation of the cam 44 in effect expands the sash shoe 42 within the channel 32 such that the sash shoe 42 becomes wedged and locked in position within the channel 32 and vertical movement of the sash shoe 42 and window sashes 12,14 under the force of the counterbalance assembly or otherwise is thereby prevented.

Specifically, and as illustrated in FIG. 9, as the cam 44 is rotated the legs 54,56 are urged laterally outwards and apart, as indicated by arrow A, such that the distal ends of the legs 55,57 abut against the side wall 13 of the channel 32. The locking blocks 58,60 are also simultaneously urged and moved diagonally outwards and apart with respect to the sash shoe 42 and channel 32 and generally towards and into the corner regions 102 of the window channel 32 and into abutment with both the side walls 13 and rear wall 11 of the window channel. The movement of the locking blocks 58,60 also urges the front of the sash shoe 42 (on the opposite side of the sash shoe 42 to the locking blocks 58,60) against the front wall 14a,14b of the window jamb channel 32. The abutting of the legs 54,56, and locking blocks 58,60 against the channel walls 14a,14b,13,11 and increasing abutting pressure that is applied as the legs 54,56, and locking blocks 58,60 are urged further against the channel 32 walls by continued rotation of the cam 44, frictionally engages the legs 54,56, and locking blocks 58,60 and so locks the sash shoe 42 within the channel 32 at that particular vertical position along the channel 32 length. Accordingly in this way the sash shoe 42 is braced and wedged within the channel with the sash shoe 42 engaging and abutting in multiple (in this case four principal directions as shown by arrow A and B) generally opposing directions against the front 14a,14b, and rear walls 11 as well as against both opposite lateral side walls 13, and within the corner regions 102 between the side walls 13 and rear wall 11.

When the window sashes 12,14 are tilted back into their vertical positions the cam 44 is rotated back into the first unlocked rotational position. The legs 54,56, and locking blocks 58,60 return under the resilience of the plastic moulding, to their original retracted positions free from the channel walls 32 with the sash shoe 42 in effect contracting to an unlocked state in which the sash shoe 42 is again free to slide within the channel 32.

In this arrangement locking of the sash shoe 42, by rotation of the cam 44, occurs automatically when the window sashes 12,14 are tilted. It will though be appreciated that in other modified arrangements the cam 44 could be arranged to be rotated independently of the lower pivot mounting pin 22 by a suitable actuator arrangement to thereby rotate and lock the sash shoe 42, and so window sashes 12,14, independently of titling of the window sashes 12,14 and rotation of the lower pivot mounting pin 22 (or preferably semi-independently with titling also still causing locking of the sash shoe 42). In such a case the sash shoe 42 can then be used to operatively lock the vertical position of the window sashes 12,14 in use in an open or closed position.

It will also be appreciated that the orientation of the sash shoe 42 within the channel 32 could be changed with the legs 54,56 being disposed against the rear wall 11 and the locking blocks 58,60 adjacent and abutting against the front 14a,14b and side walls 13, although this is less preferred. The legs 54,56 and locking blocks 58,60 could also be pivoted and mounted from the sash shoe body 40 from a lower or bottom end rather than from the top or upper positions as shown. In other words the sash shoe 42 could be oriented vertically within the channel in the opposite way to that shown. Such an arrangement would provide better engagement with vertical upwards movement of the sash shoe 42 when in the locked condition causing the legs 54,56 and locking blocks 58,60 to further engage the be further urged against the channel 32. However such an alternative arrangement is less preferred since it may give rise to unintentional jamming of the sash shoe 42 when in an unlocked condition. Further moveable locking elements (eg. legs 54,56 or locking blocks 58,60) could also be provided, and whilst the paired arrangement of legs 54,56 and locking blocks 58,60 is preferred and provides balanced locking, single, or an uneven number of movable elements could be provided, but again are less preferred. The detailed configuration of the sash shoe assembly could also be modified from that shown, and alternative cam profiling and cam surfaces could be used to achieve the same functionality. Various other modifications of the particular detailed embodiment and arrangement described above and illustrated will also be apparent to those skilled in the art.

1. A locking balance shoe for a sash window counterbalance arrangement in which the balance shoe is slidably mounted within a window jamb channel defined by a plurality of walls, the balance shoe comprising:
a main body;
at least one moveable locking abutment element movable from a first unlocked position to a second engaged locking position in which, in use, the at least one locking abutment element abuts and frictionally engages a wall of the window jamb channel; and
a cam mounted within the main body which is moveable to operatively move and urge the at least one locking abutment element from the first unlocked position to the second engaged locking position;
wherein the at least one moveable locking abutment element is diagonally movable and is moved diagonally by the cam with respect the main body and channel, and in which in the second engaged locking position the at least one moveable locking abutment element is arranged to engage and abut against and within a corner region of the window jamb channel between a pair of a plurality of walls of the window jamb channel.

2. A locking balance shoe as claimed in claim 1 in which the at least one moveable locking abutment element comprises a pair of opposed diagonally moveable locking elements.

3. A locking balance shoe as claimed in claim 1 further comprising a further pair of laterally moveable locking elements which are arranged to abut against opposed lateral walls of the window jamb channel.

4. A locking balance shoe as claimed in claim 3 in which the pair of laterally moveable locking elements comprise legs which extend and are cantilevered from the main body, the legs having a distal free end which can be flexed outwards.

5. A locking balance shoe as claimed in claim 4 in which the legs include pockets having voids defined within the legs.

6. A locking balance shoe as claimed in claim 1 wherein the at least one moveable locking abutment element includes at least four moveable locking abutment elements which are operatively moveable by the cam in four generally opposed directions.

7. A locking balance shoe as claimed in claim 1 in which the cam comprises a generally cylindrical member rotatably mounted within the balance shoe.

8. A locking balance shoe as claimed in claim 1 in which the cam comprises a first curved cam surface, and the at least one diagonally movable locking abutment element cooperating curved surfaces which abut against the first curved cam surface.

9. A locking balance shoe as claimed in claim 8 in which the cam comprises a generally cylindrical member rotatably mounted within the balance shoe, and the first curved cam surface comprises a circumferentially extending axial end portion of the cylindrical cam.

10. A locking balance shoe as claimed in claim 1 wherein the at least one moveable locking abutment element includes a plurality of moveable locking abutment elements all of which abut against the cam such that the cam operatively simultaneously moves and urges all of the moveable locking abutment elements.

11. A locking balance shoe as claimed in claim 1 in which the cam is adapted to be fixedly engaged by a distal end of a pivot pin of the sash window such that the cam is rotated by rotation of the pivot pin.

12. A locking balance shoe as claimed in claim 11 in which a slot recess is defined within the cam to cooperatively engage a T shaped head of the pivot pin.

13. A locking balance shoe as claimed in claim 12 in which the main body includes a removal slot defined therein with which the slot recess of the cam can be aligned to allow sliding removal of the pivot pin along the slot and from engagement in the cam.

14. A locking balance shoe as claimed in claim 13 in which the removal slot defined in the main body diverges and widens from and end adjacent to the cam.

15. A locking balance shoe as claimed in claim 13 in which the balance shoe further comprises a removal slot closure element which fits into and substantially fills the removal slot in the main body.

16. A locking balance shoe as claimed in claim 15 in which lateral flanges project from the removal slot closure element and are slidingly engaged within corresponding recesses defined in the removal slot to retain the closure element within the removal slot.

17. A locking balance shoe as claimed in claim 1 in which the at least one diagonally moveable locking abutment element is interconnected to the main body by a relatively flexible interconnection.

18. A locking balance shoe as claimed in claim 17 in which the interconnection between the at least one diagonally moveable locking abutment element and main body comprises a reduced cross section connection.

19. A locking balance shoe as claimed in claim 17 in which the interconnection between the at least one diagonally moveable locking abutment element and main body comprises an S shaped interconnection which extends from the main body in an S shape to provide an extended interconnection path therebetween.

20. A locking balance shoe as claimed in claim 1 in which the locking balance shoe is made from molded plastic.

21. (Cancelled)

22. A method of locking a sash window balance shoe within a sash window jamb channel, the method comprising the steps of:
providing the sash window balance shoe with at least one movable locking abutment element; and
diagonally moving the at least one movable locking abutment element diagonally outwardly relative to the sash window balance shoe from a first unlocked position to a second engaged locking position such that the at least one locking abutment element abuts and frictionally engages a corner region of the window jamb channel between a pair of a plurality of walls of the window jamb channel;

23. A method of locking a sash window balance shoe as claimed in claim 22 in which the at least one movable locking abutment element comprises a pair of oppositely movable opposed locking abutment elements.

24. A method of locking a sash window balance shoe as claimed in claim 22 further comprising the steps of:
providing a pair of said laterally moveable locking abutment elements; and
moving the pair of laterally moveable locking abutment elements oppositely laterally outwards to abut against opposed lateral walls of the window jamb channel substantially simultaneously with moving the at least one moveable locking abutment element diagonally outwardly.

25. A method of locking a sash window balance shoe as claimed in claim 22 further comprising the step of providing at least four said moveable locking abutment elements, and in which the steps of moving of the moveable locking abutment comprises the steps of moving the at least four moveable locking elements in four generally opposed respective directions.

26. A method of locking a sash window balance shoe as claimed in claim 22 in which the moving of the at least one moveable locking abutment element comprises the step of rotating a locking cam rotatably disposed in the sash window balance shoe, the locking cam having a profiled cam surface which abuts against and actuates the at least one moveable locking abutment element.
